(19) United States
(12) Patent Application Publication
(10) Pub. No.: US 2011/0093300 A1
(43) Pub. Date: Apr. 21, 2011

(54) Method of Processing Travel Ticket Data

(75) Inventors: Daniel Fauleau, Mondeville (FR); Thierry D'Athis, Versailles (FR); Jean Leonetti, Saint Michel Sur Orge (FR)

(73) Assignee: THALES, NEUILLY SUR SEINE (FR)

(21) Appl. No.: 11/571,267

(22) PCT Filed: Jun. 21, 2005
(86) PCT No.: PCT/EP05/52895

§ 371 Date: Dec. 23, 2006

(30) Foreign Application Priority Data
Jun. 25, 2004 (FR) 04 07018

(51) Int. Cl. G07B 15/02; G06Q 10/00

(52) U.S. Cl. 705/5

(57) ABSTRACT

The invention relates to a method of processing data from a travel ticket, whereby the data stored in the ticket comprise contract instances, i.e. data relating to the use of a transport service. The inventive method comprising the following steps consisting in: reading a pre-selection file which contains a record of each stored contract instance, each record comprising at least one selection field and a pointer to reference a contract instance; and preparing a pre-selection list from the data read in the pre-selection file, said pre-selection list referencing the stored contract instances by order of preference. In this way, the contract instance data can be read in said order of preference, thereby accelerating processing speed since it is not necessary for all of the contract instance data to be read.

### CROSS-REFERENCE TO RELATED APPLICATIONS

The present Application is based on International Application No. PCT/EP2005/052895 filed on Jun. 21, 2005 which in turn corresponds to France Application No. 04 07018 filed on Jun. 25, 2004 and priority is hereby claimed under 35 USC §119 based on these applications. Each of these applications are hereby incorporated by reference in their entirety into the present application.

### BACKGROUND OF THE INVENTION

The present invention relates to a method of processing travel ticket data.

A travel ticket is what enables a user to use public transport services, such as the subway, train, bus, and so on. A travel ticket comprises a physical medium, the ticket, on which data is stored. Thus, a distinction is drawn between the logical medium (travel ticket), that is, the combination of the physical medium and its data, and the physical medium as such. The physical medium can use various technologies: magnetic, chip card, with or without contacts, chip token, etc. The stored data is data relating to one or more contracts for use of a travel service. A contract for use of a travel service is routinely called a product, because that is what is sold by the travel operators. A product can be, for example, a monthly subscription to a subway service in a predetermined geographic area. A product or contract instance is the data associated with a contract that is stored on a physical medium. Other data can be stored on the physical medium. Such other data can be personal data (name, address, date of birth, etc.) describing the holder of the travel ticket. Naturally, anonymous travel tickets (subway tickets for example) do not include personal data.

Conventionally, a product instance is stored in the form of a file. The file comprises a number of records each with the same format. A record is made up of fields. The CEN (European Committee for Standardization) standard ENV 1545 (1998) defines, for example, stored data field formats. There are numerous fields in a contract instance file. There are, in particular, a pricing field, an instance identification field, sale-related fields, fields relating to the validity of the contract, and so on. The pricing field can be coded by an integer number identifying the rules that apply to determining the price, validating and checking a contract. These rules and their application are known to the system, in particular the front-end equipment. The instance identification field is a unique serial number that enables this contract instance to be identified. The sale-related fields comprise, for example, the date and time of sale of the contract, a number identifying the front-end equipment used for the sale, and so on. The fields relating to the validity of the contract comprise, for example, information on the point of departure of the journey, the destination, the number of areas allowed, a validity end date, and so on.

The equipment performing read or write operations on the travel tickets are called front-end equipment, in other words equipment belonging to the “front office”. They are also called media access devices, MAD for short. Such equipment includes validators, which can be used to validate a ticket on entering a paying area (“check-in”) or on leaving it (“check-out”). The validators must process the tickets quickly. This processing time requirement does not allow the validators to read all the data of the stored contract instances.

The inventive method enables front-end equipment such as a validator to select the most appropriate contract, and do so with a reduced processing time.

### SUMMARY OF THE INVENTION

To this end, the subject of the invention is a method of processing a travel ticket in which contract instances are stored, characterized in that:
a preselection file is read, the preselection file comprising a record for each stored contract instance, each record comprising at least one selection field and a pointer referencing a contract instance,
a preselection list is prepared, from the data read from the preselection file, the preselection list referencing the stored contract instances in order of preference.

Another subject of the invention is a travel ticket in which contract instances are stored, characterized in that a preselection file is also stored, the preselection file comprising a record for each stored contract instance, each record comprising at least one selection field and a pointer referencing a contract instance, the preselection file being intended for use by this method.

The invention offers several advantages. On the one hand, the invention makes it possible in addition to apply complex selection rules when choosing the most appropriate contract.

On the other hand, the invention is particular useful when a travel ticket is shared by several different travel operators. In practice, in such a context, a travel ticket can contain a plurality of contracts originating from different operators, some operators not being able to process the data of other operators.

Still other advantages of embodiments according to the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

Other characteristics and advantages of the invention will become apparent from reading the detailed description that follows, given by way of non-limiting example and with reference to the appended drawings, which represent:

FIG. 1, an exemplary method according to the invention,

FIG. 2, an exemplary file stored on the travel ticket to implement the method according to the invention.

### DETAILED DESCRIPTION OF THE DRAWINGS

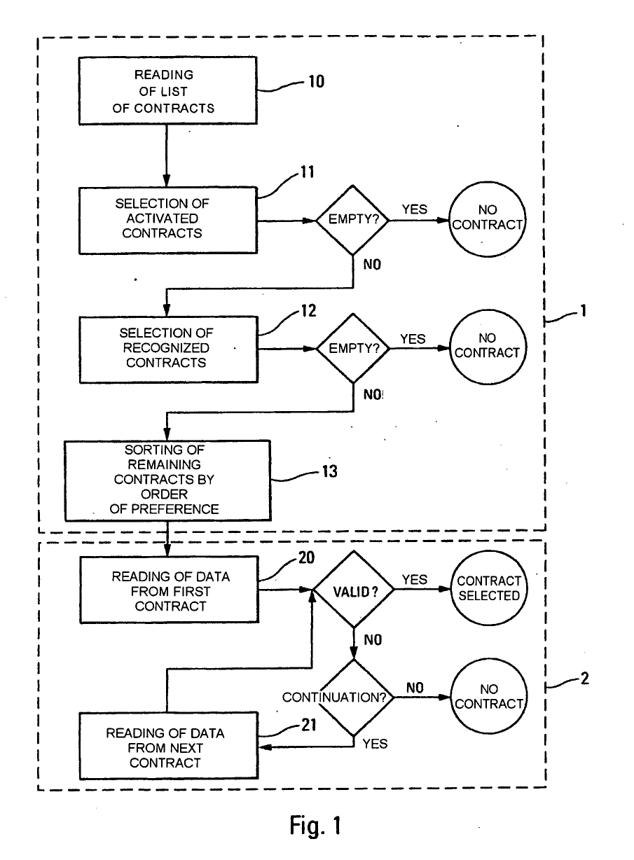

Reference is now made to FIG. 1. According to the invention, a preselection file is stored in the travel ticket. The preselection file contains certain contract-related information, and more specifically, information relating to the contract instances stored in the travel ticket. The preselection file is a kind of summary of the information contained in the contract instances, this summary being used to make a preselection. Preselection 1 is a process during which a preselection list is prepared, the preselection list referencing the contract instances in order of preference of use. An example of such processing will be described in greater detail below.

Once the preselection 1 is completed, the data of the contract instances selected in the preselection step can be read, in the order of preference of use, until a usable contract instance is obtained. This contract instance corresponds to the selected contract. The data of that contract instance can then be processed to perform a validation, for example, on checking in to or checking out of a paying area.

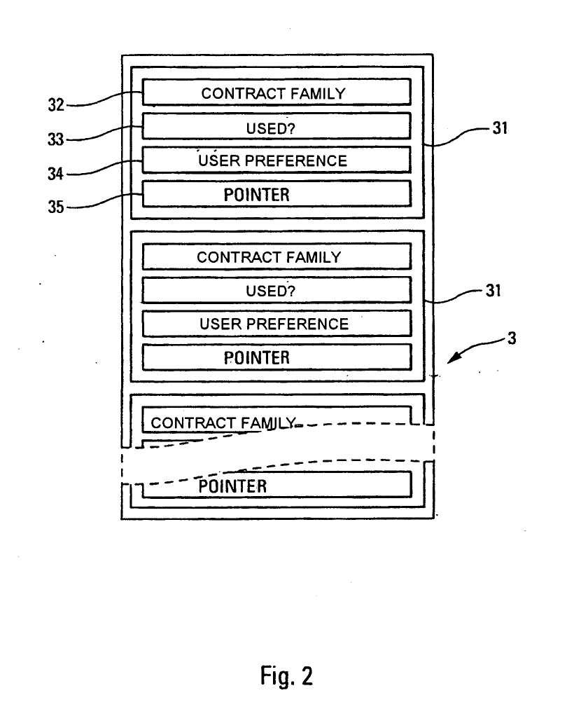

Reference is now made to FIG. 2. The preselection file 3 contains a record 31 for each contract instance. Each record has the same format and is made up of fields 32, 33, 34, 35. These fields include selection fields 32, 33, 34 and a pointer 35. The pointer 35 is used to associate a record of the preselection file with a particular contract instance.

According to the invention, a user priority associated with each product instance is defined. A user priority represents a preference expressed by the user in the order of use of the products that are held in his travel ticket. The user priority can be data contained in a selection field.

According to the invention, a standby state is also defined. When a product is in a standby state, it cannot be used by front-end equipment without first having been activated. The standby state can be data contained in a selection field.

According to an advantageous embodiment, the user priority and the standby state are coded in one and the same selection field 34. This field, denoted “UserPreference” in the description below, can be coded by an integer number, for example. One value of this integer number is used to mark the products in a standby state. The other values of this integer number can be used to define a user priority. In this case, the act of defining a user priority implicitly means that a product is activated, and the act of placing a product in a standby state prevents a user priority from being defined for that product. This is not a problem inasmuch as a product placed in a standby state must never be used.

Naturally, different selection fields can be used on the one hand to store the user priority, and on the other hand to mark the products that are in a standby state.

According to a practical embodiment, the “UserPreference” field is coded on one byte. The user priorities can have three values (1, 2 and 3 for example), the lowest value corresponding to the least preferred product, the highest value corresponding to the preferred product. The standby state of the product can be associated with a lower value (0) than the lowest priority (1).

In the description below, the possible values of the “UserPreference” field are designated, in ascending order, “preferred product”, “normal product”, “less preferred product”, and “suspended product”, the “suspended product” value corresponding to a product in the standby state.

When a product is sold, a product instance can be stored in the travel ticket with a user priority that has a default “normal product” value. Naturally, this default value can be replaced by another value specified by the user.

There now follows a description of other possible selection fields. A selection field 33 can be used to determine whether or not a particular instance is already being used. Such a situation can occur in the case of a transfer from one mode of transport to another, for example. This field makes it possible to resolve potential conflicts in the search for contracts, that is, to use a current contract rather than use a new one. This field 33 can be coded by a logic value, that is, a Boolean-type value. This field is designated “IsUsed” in the description below.

Another selection field 32 can contain an identifier defining the contract family to which each contract instance belongs. A contract family corresponds to a general definition of the contract, that is, to a contract class (or “template”). The identifier can be coded by an integer number. This field 32 is designated “ProductTemplate” in the description below.

In a multi-operator context, the product families have a unique identifier that is shared by the travel operators. In other words, there is no contention between the numbers identifying the contract families of different travel operators.

A contract family defines, for example:
the list of travel operators with which a contract of this family can be used,
the list of modes of transport that can be used with the contracts of this family,
the list of geographic areas in which the holder of a contract of this family can travel,
the list of transport lines (train, subway, bus, etc.) that can be used by the holder of a contract of this family,
characteristics concerning the time validity limits of the contracts of this family, and so on.

Other characteristics can be defined in a contract family, these characteristics not being of use to the preselection step. It is possible in particular to define the name of the family, the list of retailers authorized to sell the products of this family, the list of authorized passenger profiles (student, military, elderly person, etc.) and so on.

Reference is again made to FIG. 1 to describe in more detail the example of application of the method of selecting a product to be validated. The selection method comprises two main steps, a preselection step 1 according to the invention, and a step for selecting the product to be validated 2 based on the result of the preselection.

The preselection begins by reading 10 all the records of the preselection file to compile an initial preselection list. From this initial preselection list, one or more filtering steps are carried out, these filtering steps being optional. They make it possible to retain from the instances stored in the travel ticket only those that are relevant.

A first filtering step 11 consists in retaining only activated contracts, that is, ones for which the contract is not in a standby state. This filtering is performed simply by eliminating from the preselection list those records for which the “UserPreference” field 34 has a “suspended product” value.

A second filtering step 12 consists in retaining only the contracts recognized by the travel operator whose equipment is seeking to process the travel ticket. This filtering is performed simply by eliminating from the preselection list those records for which the “ProductTemplate” field 32 has a value that is not included in a predetermined list of the equipment.

Naturally, the filtering steps described above are given purely for illustration purposes. Variants can be envisaged to eliminate records (each record corresponds to a contract instance) from the preselection list.

If, on completion of one or other of the filtering steps, the preselection list is empty, the processing of the ticket is stopped without any contract having been able to be selected.

There now follows a description of the sorting step 13 of the contracts referenced by the preselection list (remaining after filtering where appropriate) in order of preference. The contracts can be sorted practically by sorting the records of the preselection list. The records can be classified by using various successive sort criteria.

A first sort criterion can be based on the value of the “IsUsed” field 33. In other words, preference will be given to the priority use of a current contract rather than a new contract.

A second sort criterion can be based on the value of the user priority. For this purpose, the value of the “UserPreference” field 34 is used. In this advantageous embodiment, all that is required is to classify the records with the value of this field (in descending value order). It will be noted that the presence of the preceding filtering step 11 renders the use of a coding of the standby state and of the user priority in a single field even more practical.

A third sort criterion can be based on a priority given by the travel operator to which the equipment processing the ticket belongs. This sort criterion can be based on the value of the “ProductTemplate” field 32. A travel operator can thus choose to give preference to validating a contract that he has sold rather than a contract sold by a third party.

A fourth sort criterion can be to give priority to selecting the most recent contracts. To this end, the records can be sorted in order of appearance in the initial preselection list, inasmuch as the records corresponding to the new contracts are placed at the start of the preselection file. This can be done simply by numbering the records when reading the preselection file, this number then being used for the fourth sort criterion.

At the end of the sorting process, there is a preselection list with records sorted in order of preference. This preselection makes it possible to save time in the rest of the processing because most of the unusable contracts are already deleted, their data not having needed to be read, and because the remaining contracts are sorted.

There now follows a description of the step 2 for selecting the product to be validated. The data of the first contract referenced by the preselection list is read 20. From this data, the geographic and time validity of the contract is tested. If the contract is valid, it is selected.

Otherwise, the processing is continued with the data of the next contract being read 21.

Of course, the invention is not limited to this embodiment described. It will be understood, for example, that the order in which the sorting or filtering steps are performed is unimportant, the sorting step possibly, for example, preceding the filtering steps, or certain filtering steps only.

It will be readily seen by one of ordinary skill in the art that embodiments according to the present invention fulfill many of the advantages set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

1. A method of processing a travel ticket in which contract instances are stored, wherein:
a preselection file is read, the preselection file comprising a record for each stored contract instance, each record comprising at least one selection field and a pointer referencing a contract instance,
a preselection list is prepared, from the data read from the preselection file, the preselection list referencing the stored contract instances in order of preference.

2. The method as claimed in claim 1, wherein the preselection list is made up of records read from the preselection file.

3. The method as claimed in claim 1, wherein a selection field comprises data relating to a user priority, the user priority being a preference of the user in the order of use of the products that are held in his travel ticket, this selection field being used when preparing the preselection list to sort the stored contract instances.

4. The method as claimed in claim 1, wherein a selection field comprises data relating to a standby state, a contract in standby state being a contract whose use by front-end equipment is prohibited without it having first been activated, this selection field being used when preparing the preselection list to filter the contract instances in standby state.

5. A travel ticket in which contract instances are stored, comprising a preselection file, the preselection file comprising a record for each stored contract instance, each record comprising at least one selection field and a pointer referencing a contract instance, the preselection file being intended for use by the method as claimed in claim 1.

6. The travel ticket as claimed in claim 5, wherein a selection field comprising data relating to a user priority, the user priority being a preference of the user in the order of use of the products held in his travel ticket.

7. The travel ticket as claimed in claim 5, wherein a selection field comprising data relating to a standby state, a contract in the standby state being a contract for which the use by front-end equipment is prohibited without it having first been activated.

8. The travel ticket as claimed in claim 6, wherein a single selection field comprising the data relating to the user priority and the data relating to the standby state.

9. The travel ticket as claimed in claim 7, wherein a single selection field comprising the data relating to the user priority and the data relating to the standby state.
